(19) United States
(12) Patent Application Publication
(10) Pub. No.: US 2024/0379976 A1
(43) Pub. Date: Nov. 14, 2024

(54) FLUIDIC COOLANT SYSTEM AND APPARATUS FOR A FUEL CELL STACK

(71) Applicant: GM GLOBAL TECHNOLOGY OPERATIONS LLC, Detroit, MI (US)

(72) Inventors: Thomas Shock, Commerce Township, MI (US); Eric Nguyen, Oak Park, MI (US)

(73) Assignee: GM GLOBAL TECHNOLOGY OPERATIONS LLC, Detroit, MI (US)

(21) Appl. No.: 18/315,201

(22) Filed: May 10, 2023

(51) Int. Cl. H01M 8/04029; B01D 15/36; F28F 9/26; H01M 8/04007

(52) U.S. Cl. CPC H01M 8/04029; B01D 15/361; F28F 9/26; H01M 8/04074; H01M 2008/1095

(57) ABSTRACT

A fluidic coolant system for a fuel cell stack that includes a fluidic pump, a heat exchanger, and an ion exchange filter housing assembly is described. A fluidic outlet of the heat exchanger is fluidly coupled to the fluidic pump, and a fluidic inlet of the heat exchanger is fluidly coupled to the fuel cell stack. The fluidic pump is arranged to supply coolant from the heat exchanger to the fuel cell stack and the ion exchange filter housing assembly.

### INTRODUCTION

A fuel cell is an electro-chemical device that converts chemical energy of a fuel, e.g., hydrogen, into electrical power by an electro-chemical reaction. Multiple fuel cells may be combined to form a fuel cell stack to generate a desired fuel cell power output. The electric power generated by a fuel cell stack may be used to power an electric machine, such as an on-vehicle traction motor or a stationary generator.

One type of fuel cell includes a polymer electrolyte membrane (PEM) fuel cell. The PEM fuel cell may include three basic components: a cathode, an anode, and an electrolyte membrane. The cathode and the anode may include a finely divided catalyst, such as platinum, supported on carbon particles and mixed with an ionomer. The electrolyte membrane is sandwiched between the cathode and the anode to form a membrane-electrolyte-assembly (MEA). The MEA is often disposed between porous diffusion media (DM), which facilitate a delivery of gaseous reactants, e.g., hydrogen and oxygen, for an electrochemical fuel cell reaction. Individual fuel cells can be stacked together in series to form a fuel cell stack.

During operation of the fuel cell stack, the fuel cell stack temperature is generally maintained within a desired range for the electrochemical fuel cell reaction. A coolant system including a coolant tank and coolant lines are in fluid communication with the fuel cell stack. Coolant is supplied to the fuel cell stack for regulating the temperature thereof. The coolant supplied to the fuel cell stack is desired to have a minimal electrical conductivity. If ions are present in the coolant, electrical conductivity of the coolant may increase with a resulting decrease in power generation efficiency of the fuel cell stack.

### SUMMARY

To avoid a decrease in efficiency of a fuel cell stack caused by coolant ionization, an ion-exchange device for removing ions in the coolant may be employed as part of a cooling system. There is a need to periodically service an ion-exchange device to minimize waste, minimize a loss of the coolant during the service, and minimize the exposure of the coolant system to contamination from the environment. Furthermore, there is a need for an integrated housing for an ion-exchange device with closing and sealing functions.

An aspect of the disclosure may include a fluidic coolant system for a fuel cell stack that includes a fluidic pump, a heat exchanger, and an ion exchange filter housing assembly. A fluidic outlet of the heat exchanger is fluidly coupled to the fluidic pump, and a fluidic inlet of the heat exchanger is fluidly coupled to the fuel cell stack. The fluidic pump is arranged to supply coolant from the heat exchanger to the fuel cell stack and the ion exchange filter housing assembly.

Another aspect of the disclosure may include the heat exchanger being an air/fluid heat exchanger.

Another aspect of the disclosure may include the ion exchange filter housing assembly including a fluidic canister including a filter housing and a cap, wherein the fluidic canister defines an inner chamber including a filter chamber and an expansion chamber. Also included are an ion exchange filter; a fluidic inlet port; a fluidic outlet port; a first air vent inlet; and a second air vent inlet. The ion exchange filter is disposed within the filter chamber of the inner chamber, wherein the expansion chamber is formed within the fluidic canister. The fluidic inlet port is arranged on the fluidic canister on a first side of the ion exchange filter, the fluidic outlet port is arranged on the fluidic canister in the expansion chamber on a second side of the ion exchange filter, and the first air vent inlet and the second air vent inlet are arranged on the cap and are fluidly connected to the expansion chamber.

Another aspect of the disclosure may include the filter housing being arranged as a prismatic device.

Another aspect of the disclosure may include the filter housing being arranged as a cylindrical device.

Another aspect of the disclosure may include the ion exchange filter housing assembly having a pressure relief valve that is arranged in the cap.

Another aspect of the disclosure may include the first air vent inlet being fluidly connected to the fuel cell stack.

Another aspect of the disclosure may include the second air vent inlet being fluidly connected to the heat exchanger.

Another aspect of the disclosure may include the cap being sealably assemblable onto the filter housing, wherein the ion exchange filter is arranged within the filter chamber of the inner chamber when the cap is sealably assembled onto the filter housing, and wherein the ion exchange filter is removable from the inner chamber when the cap is disassembled from the filter housing.

Another aspect of the disclosure may include the fluidic outlet port of the ion exchange filter housing assembly being fluidly connected to a fluidic inlet of the fluidic pump.

The above summary is not intended to represent every possible embodiment or every aspect of the present disclosure. Rather, the foregoing summary is intended to exemplify some of the novel aspects and features disclosed herein. The above features and advantages, and other features and advantages of the present disclosure, will be readily apparent from the following detailed description of representative embodiments and modes for carrying out the present disclosure when taken in connection with the accompanying drawings and the claims.

### BRIEF DESCRIPTION OF THE DRAWINGS

One or more embodiments will now be described, by way of example, with reference to the accompanying drawings, in which:

FIG. 1 schematically illustrates an existing fluidic circuit for circulating coolant to a fuel cell stack.

FIG. 2 schematically illustrates elements of a novel fluidic coolant system that is fluidly coupled to and arranged to supply and circulate liquid coolant to a fuel cell stack, in accordance with the disclosure.

FIG. 3 schematically illustrates an embodiment of an ion exchange filter housing assembly for an embodiment of the fluidic coolant system described with reference to FIG. 2, in accordance with the disclosure.

FIG. 4 schematically illustrates another embodiment of an ion exchange filter housing assembly for an embodiment of the fluidic coolant system described with reference to FIG. 2, in accordance with the disclosure.

The appended drawings are not necessarily to scale, and may present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material that is understood in the related art has not been described in detail in order to avoid unnecessarily obscuring the disclosure.

For purposes of convenience and clarity only, directional terms such as top, bottom, left, right, up, over, above, below, beneath, rear, and front, may be used with respect to the drawings. These and similar directional terms are not to be construed to limit the scope of the disclosure. Furthermore, the disclosure, as illustrated and described herein, may be practiced in the absence of an element that is not specifically disclosed herein.

The following detailed description is merely exemplary in nature and is not intended to limit the application and uses. Furthermore, there is no intention to be bound by any expressed or implied theory presented herein. Throughout the drawings, corresponding reference numerals indicate like or corresponding parts and features.

For purposes of the present description, unless specifically disclaimed, use of the singular includes the plural and vice versa, the terms “and” and “or” shall be both conjunctive and disjunctive, and the words “including,” “containing,” “comprising,” “having,” and the like shall mean “including without limitation.” For example, “optimal vehicle routes” may include one or more optimal vehicle routes. Moreover, words of approximation such as “about,” “almost,” “substantially,” “generally,” “approximately,” etc., may be used herein in the sense of “at, near, or nearly at,” or “within 0-5% of”, or “within acceptable manufacturing tolerances”, or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

As used herein, the term “system” may refer to one of or a combination of mechanical and/or electrical devices including actuators, sensors, controllers, application-specific integrated circuits (ASIC), combinatorial logic circuits, software, firmware, and/or other components that are arranged to provide the described functionality.

As employed herein, the term “upstream” and related terms refer to elements that are towards an origination of a flow stream relative to an indicated location, and the term “downstream” and related terms refer to elements that are away from an origination of a flow stream relative to an indicated location.

The use of ordinals such as first, second and third does not necessarily imply a ranked sense of order, but rather may only distinguish between multiple instances of an act or structure.

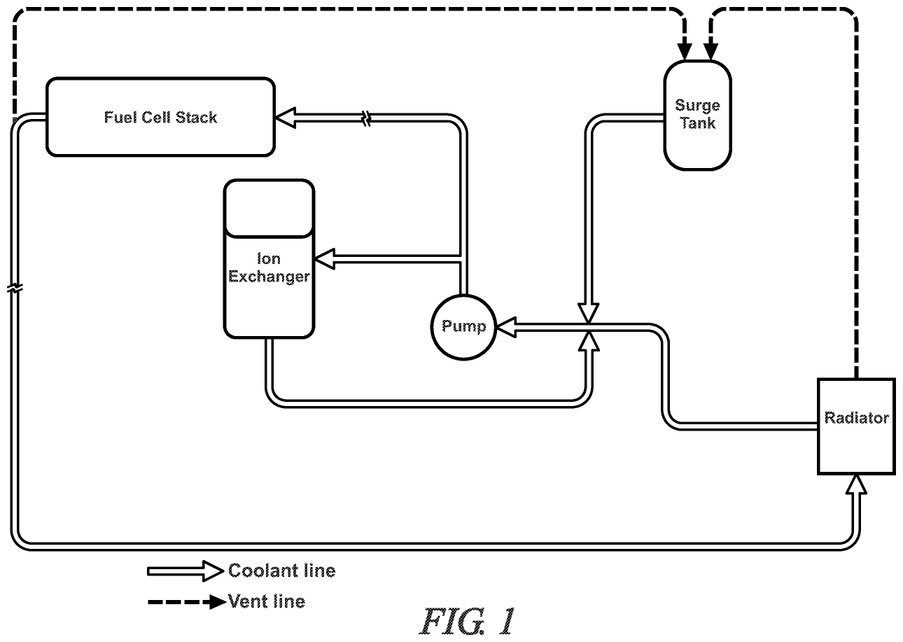

Referring now to the drawings, which are provided for the purpose of illustrating certain exemplary embodiments only and not for the purpose of limiting the same, FIG. 1 schematically illustrates an existing fluidic circuit for circulating coolant to a fuel cell stack. The fluidic circuit includes an ion exchanger, a surge tank, a heat exchanger (RAD), and a fluidic pump (P), which are fluidly connected via coolant conduits. Vent conduits are arranged to channel overflows from the fuel cell stack and the heat exchanger to the surge tank.

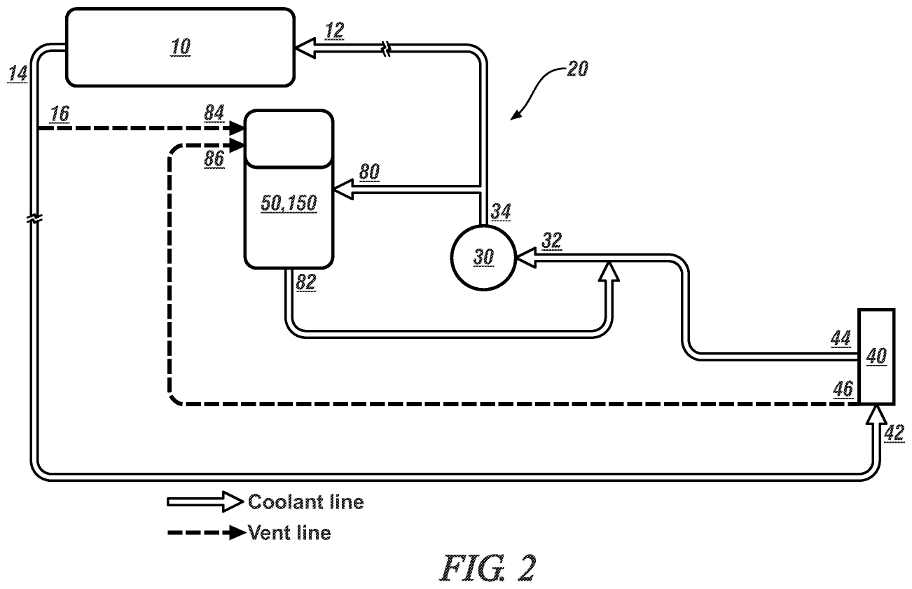

FIG. 2 schematically illustrates elements related to a fluidic coolant system 20 that is fluidly coupled to and arranged to supply and circulate liquid coolant to a fuel cell stack 10. In one embodiment, the fuel cell stack 10 may be employed on a vehicle to provide electric power for propulsion. The vehicle may include, but not be limited to a mobile platform in the form of a commercial vehicle, industrial vehicle, agricultural vehicle, passenger vehicle, aircraft, watercraft, train, all-terrain vehicle, personal movement apparatus, robot and the like to accomplish the purposes of this disclosure.

The fluidic coolant system 20 is arranged, in one embodiment, as a closed fluidic circuit that includes a fluidic pump 30, a heat exchanger 40, and an ion exchange filter housing assembly 50, all of which are fluidly coupled via closed conduits.

In one embodiment, the heat exchanger 40 is an air/fluid heat exchanger.

The fluidic pump 30 is arranged to supply liquid coolant from the heat exchanger 40 to the fuel cell stack 10 and the ion exchange filter housing assembly 50. In one embodiment, the fluidic pump 30 is a single-stage centrifugal pump that is powered by an electric motor.

The fluidic pump 30 includes a fluidic outlet 44 of the heat exchanger 40 and a fluidic outlet port 82 of the ion exchange filter housing assembly 50 being fluidly coupled via a conduit to a suction side 32 of the fluidic pump 30. A pressure side 34 of the fluidic pump 30 is fluidly coupled via a conduit to a fluidic inlet 12 of the fuel cell stack 10 and via a conduit to a fluidic inlet port 80 of the ion exchange filter housing assembly 50. A fluidic outlet 14 of the fuel cell stack 10 is fluidly coupled via a conduit to a fluidic inlet 42 of the heat exchanger 40.

A first vent line 16 is arranged to channel gaseous fluid from the fluidic outlet 14 of the fuel cell stack 10 to a first air vent inlet 84 of the ion exchange filter housing assembly 50. A second vent line 46 is arranged to channel gaseous fluid from the heat exchanger 40 to a second air vent inlet 86 of the ion exchange filter housing assembly 50.

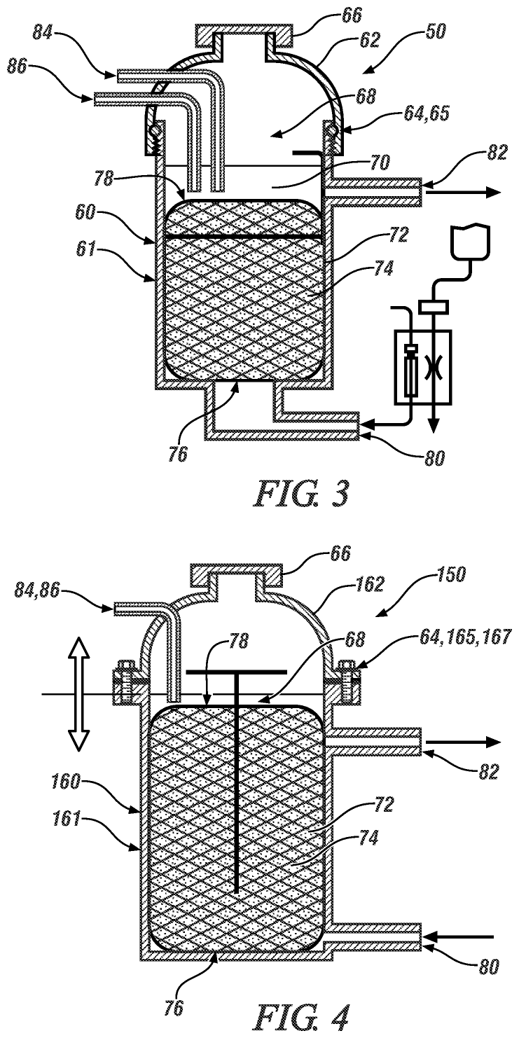

FIG. 3 schematically illustrates an embodiment of the ion exchange filter housing assembly 50, with continued reference to the fluidic coolant system 20 that is described with reference to FIG. 2. The ion exchange filter housing assembly 50 incorporates a serviceable, replaceable ion exchange filter 74 and an expansion chamber 68. The expansion chamber 68 functions as a surge tank for the fluidic coolant system 20 to capture, retain, and recirculate overflow of coolant from the fuel cell stack 10 and the heat exchanger 40.

The ion exchange filter housing assembly 50 includes a fluidic canister 60 including a filter housing 61 and an attachable/removable cap 62 that is sealably assemblable onto the filter housing 61. The cap 62 is removably and sealably secured to the filter housing 61 via an O-ring gasket 64 and a threaded interface 65 in one embodiment. The threaded interface 65 is arranged so that the cap 62 and the filter housing 61 have matching male and female helical threaded portions, which are engaged to removably attach the cap 62 to the filter housing 61.

The fluidic canister 60 defines an inner chamber 70 that is composed of the filter chamber 72 and the expansion chamber 68.

The configuration of the fluidic canister 60 is determined based upon volumetric needs for the ion exchange filter 74 and the expansion chamber 68, and on-vehicle and/or underhood packaging restraints and requirements. The fluidic canister 60 is arranged as a prismatic device in one embodiment. Alternatively, the fluidic canister 60 may be arranged as a cylindrical device in one embodiment. Alternatively, the fluidic canister 60 may be arranged in another configuration.

The ion exchange filter 74 is insertable into the filter chamber 72 of the inner chamber 70. The ion exchange filter 74 is arranged as a serviceable, removable cartridge. The ion exchange filter 74 may be arranged, in one embodiment, as a resin that operates to suppress an increase in the ion concentration in the coolant and thus reduce conductivity of the coolant, maintain electrical resistivity and a neutral pH.

The expansion chamber 68 is formed in the inner chamber 70 of the fluidic canister 60 beneath the cap 62 above the fluidic level, and between the ion exchange filter 74 and the cap 62.

The first air vent inlet 84 and the second air vent inlet 86 are disposed in the cap 62 to enable fluidic flow of gaseous fluids into the expansion chamber 68. The pressure relief valve 66 is disposed in the cap 62 and is arranged to relieve excess pressure in the expansion chamber.

The fluidic inlet port 80 receives fluidic flow of coolant from the pump 30, in parallel with the fuel cell stack 10. Coolant flows from a first side 76 of the ion exchange filter 74 to a second side 78 of the ion exchange filter 74 due to a pressure differential created by operation of the pump 30. The fluidic outlet port 82 of the ion exchange filter housing assembly 50 is fluidly coupled to the suction side 32 of the fluidic pump 30, and channels filtered coolant thereto.

FIG. 4 schematically illustrates another embodiment of the ion exchange filter housing assembly 150, with continued reference to the fluidic coolant system 20 that is described with reference to FIG. 2. The ion exchange filter housing assembly 150 incorporates a serviceable, replaceable ion exchange filter 74 and an expansion chamber 68. The expansion chamber 68 functions as a surge tank for the fluidic coolant system 20 to capture, retain, and recirculate overflow of coolant from the fuel cell stack 10 and the heat exchanger 40.

The ion exchange filter housing assembly 150 includes a fluidic canister 160 including a filter housing 161 and an attachable/removable cap 162 that is sealably assemblable onto the filter housing 161. The cap 162 is removably and sealably secured to the filter housing 161 via an O-ring gasket 64 and a clamped interface 165 in one embodiment. The cap 162 is removably and sealably secured to the filter housing 161 via a plurality of removable fasteners 167 that screw into, clamp on or otherwise sealably attached the cap 162 to the filter housing 161.

All other aspects of the fluidic canister 160 are analogous to the fluidic canister 60 that is described with reference to FIG. 3.

The concepts described herein provide for an ion exchange filter housing assembly for a fluidic coolant system having a serviceable ion exchange filter, and an integrated expansion chamber that functions as and thus supplants a surge tank.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the claims.

What is claimed is:

1. A fluidic coolant system for a fuel cell stack, comprising:
a fluidic pump, a heat exchanger, and an ion exchange filter housing assembly;
wherein a fluidic outlet of the heat exchanger is fluidly coupled to the fluidic pump;
wherein a fluidic inlet of the heat exchanger is fluidly coupled to the fuel cell stack; and
wherein the fluidic pump is arranged to supply coolant from the heat exchanger to the fuel cell stack and the ion exchange filter housing assembly.

2. The fluidic coolant system of claim 1, wherein the heat exchanger comprises an air/fluid heat exchanger.

3. The fluidic coolant system of claim 1, wherein the ion exchange filter housing assembly comprises:
a fluidic canister including a filter housing and a cap;
the fluidic canister defining an inner chamber including a filter chamber and an expansion chamber;
an ion exchange filter;
a fluidic inlet port;
a fluidic outlet port;
a first air vent inlet; and
a second air vent inlet;
wherein the ion exchange filter is disposed within the filter chamber of the inner chamber;
wherein the expansion chamber is formed within the fluidic canister;
wherein the fluidic inlet port is arranged on the fluidic canister on a first side of the ion exchange filter;
wherein the fluidic outlet port is arranged on the fluidic canister in the expansion chamber on a second side of the ion exchange filter; and
wherein the first air vent inlet and the second air vent inlet are arranged on the cap and are fluidly connected to the expansion chamber.

4. The fluidic coolant system of claim 3, wherein the filter housing is arranged as a prismatic device.

5. The fluidic coolant system of claim 3, wherein the filter housing is arranged as a cylindrical device.

6. The fluidic coolant system of claim 3, wherein the ion exchange filter housing assembly further comprises a pressure relief valve that is arranged in the cap.

7. The fluidic coolant system of claim 3, wherein the first air vent inlet is fluidly connected to the fuel cell stack.

8. The fluidic coolant system of claim 3, wherein the second air vent inlet is fluidly connected to the heat exchanger.

9. The fluidic coolant system of claim 3:
wherein the cap is sealably assemblable onto the filter housing;
wherein the ion exchange filter is arranged within the filter chamber of the inner chamber when the cap is sealably assembled onto the filter housing; and
wherein the ion exchange filter is removable from the inner chamber when the cap is disassembled from the filter housing.

10. The fluidic coolant system of claim 3, wherein the fluidic outlet port of the ion exchange filter housing assembly is fluidly connected to a fluidic inlet of the fluidic pump.

11. An ion exchange filter housing assembly, comprising:
a fluidic canister including a filter housing and a cap;
the fluidic canister defining an inner chamber including a filter chamber and an expansion chamber;
an ion exchange filter;
a fluidic inlet port;
a fluidic outlet port;
a first air vent inlet; and
a second air vent inlet;
wherein the ion exchange filter is disposed within the filter chamber of the inner chamber;
wherein the expansion chamber is formed within the fluidic canister;
wherein the fluidic inlet port is arranged on the fluidic canister on a first side of the ion exchange filter;
wherein the fluidic outlet port is arranged on the fluidic canister in the expansion chamber on a second side of the ion exchange filter; and
wherein the first air vent inlet and the second air vent inlet are arranged on the cap and are fluidly connected to the expansion chamber.

12. The ion exchange filter housing assembly of claim 11, wherein the cap is removable from the fluidic canister; and
wherein the ion exchange filter comprises a cartridge that is removable from the filter chamber when the cap is removed from the fluidic canister.

13. The ion exchange filter housing assembly of claim 11, further comprising a pressure relief valve disposed in the cap and arranged to relieve excess pressure in the expansion chamber.

14. The ion exchange filter housing assembly of claim 11, wherein the filter housing is arranged as a prismatic device.

15. The ion exchange filter housing assembly of claim 11, wherein the filter housing is arranged as a cylindrical device.

16. The ion exchange filter housing assembly of claim 11, further comprising a pressure relief valve that is arranged in the cap.

17. The ion exchange filter housing assembly of claim 11:
wherein the cap is sealably assemblable onto the filter housing;
wherein the ion exchange filter is arranged within the filter chamber of the inner chamber when the cap is sealably assembled onto the filter housing; and
wherein the ion exchange filter is removable from the inner chamber when the cap is disassembled from the filter housing.

18. The ion exchange filter housing assembly of claim 11, wherein the first air vent inlet is fluidly connected to a fuel cell stack.

19. The ion exchange filter housing assembly of claim 11, wherein the second air vent inlet is fluidly connected to a heat exchanger.

20. The ion exchange filter housing assembly of claim 11, wherein the fluidic outlet port of the ion exchange filter housing assembly is fluidly connected to a fluidic inlet of a fluidic pump.
